(19) United States
(12) Patent Application Publication
(10) Pub. No.: US 2007/0214794 A1
(43) Pub. Date: Sep. 20, 2007

(54) Supercharged subsonic rotary ramjet turbine with vibration free piston air compressor

(76) Inventor: Erik Henry Tweeton, Granby, CO (US)

Correspondence Address: Erik Tweeton, PO Box 1663, Granby, CO, 80446, US

(21) Appl. No.: 11/375,419

(22) Filed: Mar. 15, 2006

(51) Int. Cl. F02K 7/10; F02K 7/08

(52) U.S. Cl. 60/767

(57) ABSTRACT

A machine for producing mechanical rotation power consists of a one or more rotors with exhaust nozzles spaced on the outer edge spinning faster than the combustor. The system includes a vibration free piston air compressor or other air compressor to pressurize the intake air. Each of the burners include a fuel nozzle, a swirl burner, and a convergent divergent nozzle to create thrust form escaping heated combustion exhaust in the opposite direction of rotation. The burner assemblies are restricted by 2 discs on each side of the burner assembly that extend over the top of the discs to contain the burners. Multiple rotors are used on the same axle. The engine produces both thrust and rotary power with more power per size and weight greater than current piston internal combustion engines.

### BACKGROUND OF THE INVENTION

1. Field of Invention

This invention relates to rotary ramjet engines and more specifically a rotary shaft power producing engine using ramjets that are laterally spaced that produce thrust from the ends of the rotor while spinning to make drive shaft power. It also relates to normal piston internal combustion engines and turbine engines.

2. Description of Prior and Related Art

The most related prior art is described in the various patents from Ramgen Inc. See U.S. Pat. Nos. 6,694,743, 6,298,653, and 6,510,683. Also the rotary ramjet turbines that use a pre-pressure and a subsonic rotor are similar such as U.S. Pat. No. 5,660,038. Other prior art that this new invention relates to is simple turbine engines, normally with single stage compressors and turbines.

### BRIEF SUMMARY OF THE INVENTION

The present invention uses the combustion of air and fuel to create gas expelled through exhaust nozzles located on the edge of a disc to spin a disc at subsonic tangent speeds to make power that also uses a separate air compressor to pressurize the intake more than from just the ram pressure created by the velocity of the air intake. The engine may be called hereinafter SSRT for supercharged subsonic ramjet turbine. One main objective for various versions of the engine is to achieve fuel efficiency in between 40-60% with a reduced cost of individual production of each engine compared to the current competitor engines. Other objectives form an alternative embodiments are a slow idle speed, good throttle response, many hours between maintenance needs, meeting current safety standards, and a high power to size and weight ratio. The preferred embodiment has a piston air compressor which creates most of the pressure ratio since the air intake only spins at speeds less than mach 0.9. The air intake tangent velocity is about half the speed of the exhaust nozzle for the first described engine. The fist described engine contains 2 rotors connected to a drive shaft that transfers power to both a reduction drive and the unique vibration free piston air compressor.

One other embodiment described is to have a high power for size ratio and can exchange the piston compressor for an axial flow compressor for more power per size. It also has more rotors, more nozzles per rotor, and a higher pressure ratio.

One other alternative embodiment can have the tip velocity at up to 800 m/s with an efficiency of about 60%.

### BRIEF DESCRIPTION OF SEVERAL VIEWS OF THE DRAWING

FIG. 1. This is a side view of the 4.6 kilowatt first described engine that is proportionally correct.

FIG. 2. is a front view of 744 kwt (997 hp) high performance version.

FIG. 3. is the stationary burner embodiment.

### DETAILED DESCRIPTION OF THE INVENTION

This type of engine generally produces power from the combustion of fuel and air. For diesel piston engines, higher temperature means more efficiency, but how these types of rotary ramjet turbines produce power is by thrust and speed so the opposite is normally true, at least for a 10:1 compression ratio. With a 30:1 compression ratio, a hotter temperature does increase chemical driveshaft efficiency, up to a point, so the key is to match the air fuel ratio and compression ratio to get the best efficiency possible. With 30:1 compression, the best is a mixture of 30:1 air fuel ratio, but with 10:1 compression the best ratio is 60:1 air fuel ratio.

The maximum efficiency with this invention and a 30:1 compression ratio is 76% with a 30:1 air fuel ratio but only 66% efficiency with a 100:1 air fuel ratio. The actual driveshaft potential efficiency with a 10:1 compression is 30% with the hottest temperature, 47% with 30:1 air fiel ratio and 53% with 60:1 air fuel ratio with alcohol fuel. The thermal efficiency with air fuel ratios of 10:1 is 47.3%, 30:1 is 47.1% and 60:1 is 46.8%. So the thermal efficiency and actual efficiency are reversed in order of higher to lower with a 10:1 compression ratio. It takes a nozzle tangent speed of 825 m/s (2706 ft/s) with the hottest temperature compared to 574 m/s (1880 ft/sec) with 60:1 to get the maximum efficiency and more tangent velocity means exponentially more engine weight for the same power, but the hottest em e compared to 60:1 means 12% more power if the same nozzle throat diameter. With a 20:1 compression ratio, the potential efficiency is about 50-60%, but requires a higher nozzle tangent speed of 665 m/s (2180 ft/sec) with 60:1 air fuel ratio to get 56% efficiency.

There are many advantages of the described engine. It solves the problem of how to efficiently operate the rotor at comparatively slow speeds to eliminate the need for exotic very high strength to weight ratio materials operating at their maximum stress such as the metal matrix composites and carbon unidirectional fiber which are required for Ramjen Inc's engines. It shows the needed safety shrouds to contain any broken parts that commercial turbo fans are required to have, unlike any prior art rotary ramjet. The engine does not stress any part more than half its yield strength and the pressure containers can hold 4 times the pressure in order to meet current safety standards to be allowed for use as airplane engines. Also the SSRT does not require a small intake area to total rotor surface area ratio, unlike helicopter rotary ramjets and the typical prior art.

It also shows how to get multiple rotors with less complexity unlike prior art which only show one. U.S. Pat. No. 5,660,038 says it can have multiple rotors in the claims, but unlike the prior art, the present invention shows in the drawings the best way to accomplish this. It can have at least 8 burners per rotor, while the prior art has 2 or 4. These features are intended to create a more compact power-dense cubical shape with no wasted empty space ideal for motorcycles, helicopters and other engines requiring high power per size. It also solves the problem of obtaining a slow idle speed and good throttle response, not possible with centrifugal pressurized prior art, not needed for the power plant style of engines of prior art which idle at 25% speed or more, but desired for power sport engines such as motorcycles.

The engine from Ramjen Inc. that has a tangent velocity of Mach 2-4 is apparently the latest rotary ramjet engine as of 2004. It has a stationary outer shell and only the inside disk spins around. Unlike my invention, it has the exhaust and the intake spinning at the same tangent velocity and has no supercharger. Unlike the prior art rotary ramjet turbines which only operate preferably at mach 3.5 tip velocity, the first described engine embodiment operates with a 200 m/s (656 feet/sec) burner and a 400 m/s (1312 ft/sec) exhaust nozzle. The Ramjen inc. engine produces all of the compression from the speed change caused by ramjet, but the preferred engine uses a piston air compressor to produce most of the compression. The prior art increases efficiency by using the exhaust to drive a normal turbine, but this invention does not require that added assembly of parts and complexity to get the same efficiency of 40-60% claimed by prior art. Also having an outer exhaust-catcher turbine can block the nozzle exhaust and end up taking power away from the nozzle rather than adding a net power gain. Using a vacuum to reduce the air pressure surrounding the nozzle exhaust increases the thrust of the nozzle, but this method creates a net power loss.

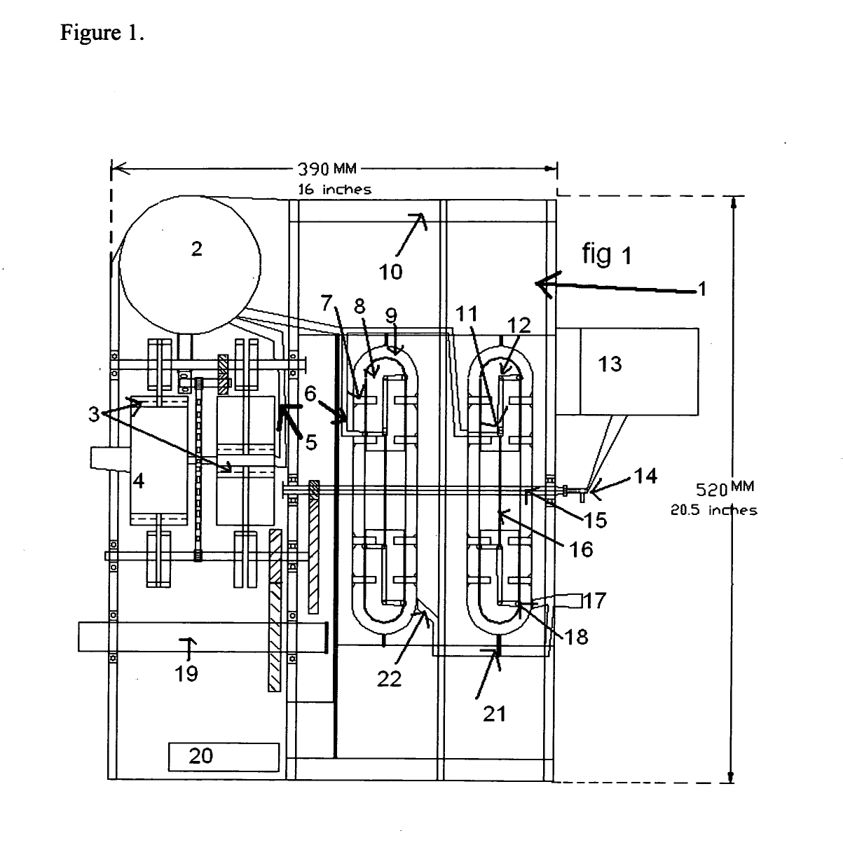

The invention is best understood by describing the preferred embodiment which is used as a proportional model so the person skilled in the art can see one of the sizes of the engine that is possible. It is shown in FIG. 1. The size of said engine is 39 cm (16 inch) by 52 cm (20 inch) by 52 cm (20 inches) and has a one inch diameter drive shaft spinning at 3000 rpm. This model is to show the engine can have about the same power for size or less as a typical power equipment piston engine in the range of 2.2-15 kwt (3-20 hp). It makes 4.6 kilowatts (6 hp) with 2 rotors and 4 burners.

It can use normal liquid fuel since the speed of the fuel nozzle compared to the base is only 200 m/s (440 mph); the fuel pressure is a reasonable 16 mpa (2320 psi) with alcohol fuel. If liquid fuel was used for the mach 3.5 engine, there would be an unmanageable destructive liquid fuel pressure of 503 mpa (73,000 psi). For small engines, the viscosity of the fuel can make the fuel delivery quite less than expected. Since the reduction in pressure goes up by the inverse of the 4^{th} power of the radius of the fuel nozzle, it becomes exponentially important for small engines with small fuel nozzles to have a controlled fuel supply.

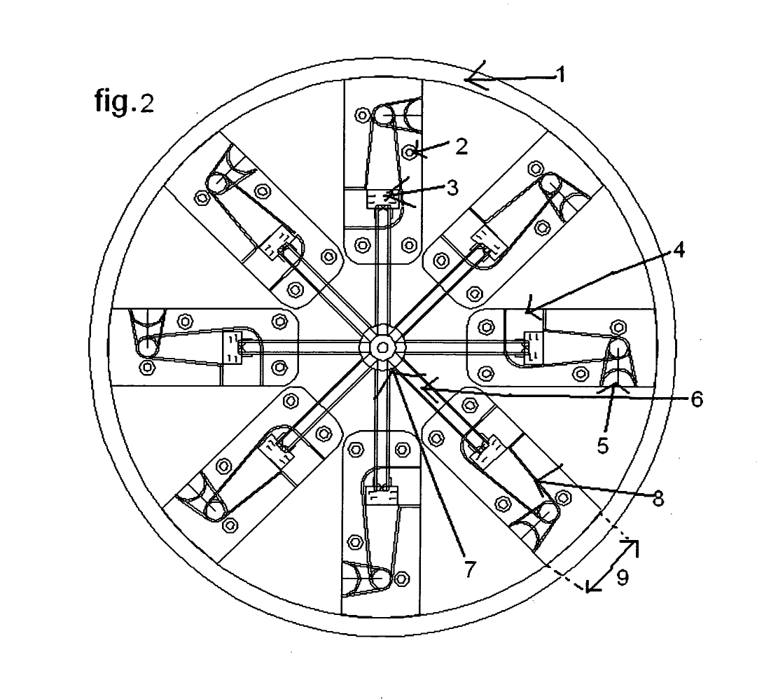

The numbers and proportions used in this description are not meant to be limiting to the specific choice of dimensions of the preferred embodiment, but rather a basis for the claims to verify to those skilled in the art that the invention is not contrary to physics, nor depends on future materials, nor violates current safety laws. FIG. 1 shows a side view of the main described 4.6 kwt (6 hp) engine. It has 21% fuel efficiency so it has no greater efficiency than a normal gasoline piston engine. Its advantages are: no vibration, it can run on different kinds of fuels, and its reliability. A modified version can have a tangent speed of 500 m/s (1640 feet per second) like the high performance engine of FIG. 2 instead of 400 m/s (1310 feet per second) to increase the efficiency to 38%; close to the diesel and normal turbine efficiencies. It has an estimated individual production cost of about half as normal high quality small piston gas engines sell for.

Number 1 is a ceramic or fiber glass blanket with separated layers of aramid cloth or similar high strength fabric to contain a broken burner if the outer rotor ribbon breaks and the burner unit flings off at full speed. It is 10 cm (3.9 inches) thick. Number 10 is on the outer layer of the blanket which is a 2 cm (¾^{th} inch) thick layer of fiberglass composite or aluminum to form the outer frame.

It (#10) needs to be the final barricade to prevent the burner from breaking out of the impact shield if it breaks free from the rotor-disc assembly. The bolts (#7) on the sides are only designed to hold the thrust of the nozzle and do not hold the centrifugal stress of the burner. They need to be countersunk and have a low drag head design even when countersunk, if they were not, the drag from each set of bolts on the burner would be about the same as the thrust. The rotor is #9 and holds the centrifugal force of the burner. The preferred material is S-glass epoxy composite and needs to be about 1 cm (0.4 inch) thick. The engine can have a faster tangent velocity of 800 m/s if the S-glass was 5 cm (2″) thick. This would allow a maximum efficiency of 57% if using a 30:1 air fuel ratio, 20:1 compression and a maximum tangent speed of 798 m/s (2618 feet per second).

Number 2 is an air tank to even out the variable air flow of the piston air compressor. It holds 1 liter (0.035 cubic foot) of air, which is about ⅕^{th} second of the pre compressed air supply at full speed. It also helps to improve throttle response. A method of starting the engine can use the air tank to hold enough air for starting the engine. There can be a small electric motor to turn the piston air compressor for a few seconds to allow the pressure to build in the small air tank until there is enough to start the engine. When the engine is turned off, the flywheel inertial effect will still turn the compressor over enough to put air in the closed air tank that can be released next time the engine is started simply by turning on the fuel pump and opening the air throttle. This allows having a smaller than average starter motor.

The pistons for the air compressor are 5 cm (1.96 inches) diameter and are #3. They move at 8.5 m/s (28 feet/second), which is fairly close to the same piston speed as a modern air plane piston engine, and a quarter of the speed of high performance racing gas piston engine oscillates. Next to the pistons are the two cylinders for the air compressor and they are #4.

There are 2 pistons in one cylinder which spin in opposite directions at 6000 rpm and both move toward and away from each other in the same straight cylinder at the same time to eliminate vibration. There is a second cylinder with the pistons moving in the opposite direction as the first piston pair and the shaft is also rotating in the other direction. Prior art air compressors only contain the produced vibration using a special vibration absorbing mounting base instead of eliminating the vibration source such as U.S. Pat. No. 6,447,257 which only has one piston and dampens some vibration. The displacement of the air compressor is about 334 cc's (20 cubic inches). The air line from the pistons to the air tank is #5.

The air intake can have a valve before compression to reduce the air intake pressure to allow the engine to operate less than full throttle. The air flows into the air intake on the burners through #6 which is a donut shaped air intake hose with labyrinth seals that do not contact. That component is intended to minimize the loss of air from the high pressure line holding a 7.9 compression ratio. The speed change of mach 0.6 from the spinning air intake section on the burners brings the pressure up to a 10:1 ratio.

The fuel system is quite simple. Number 13 is the fuel tank, #14 is the fuel shutoff valve, #15 is the hollow axle that holds the fuel. It only holds about 1 tenth of a second of fuel to allow a rapid engine slowdown if the governor stops the engine from an over-rev. Number 16 is the fuel pipe that connects the final fuel nozzle to the hollow axle. It has only a 0.4 mm (0.016 inch) inside diameter. The swirl burner and fuel nozzle are #11. The swirl burner uses the fuel air ratio of commercial plane turbofans of 1:60 to get the maximum overall efficiency instead of the 1:10 chemically (stiochiometric) proper ratio for 85% alcohol 15% gasoline.

The described engine burns pure alcohol or “E-85” ethanol because of its lower viscosity than biodiesel, but the alternative embodiments with a stationary burner can use any liquid or gas fuel that is used for other common turbines. The fuel hole size needs to be 0.0388 mm (1.5 thousands of an inch) diameter to allow 600 grams (1.32 lb) of fuel out per hour per nozzle with the 16 mpa (2320 psi) initial fuel pressure created form the centrifugal force of 200 m/s (440 mph). Running an alcohol engine on gasoline would increase the power by about 25% at full throttle, so it is preferred to have different sizes of interchangeable fuel nozzles to run the engine on the preferred fuel without unexpected increases or decreases in power. At ¾^{th} throttle, the efficiency goes down to 9% and the power is 30%. At half speed, the air compressor takes more power than the engines output. Because of this inability to idle with only a simple pre-compressor air throttle, the preferred fuel system includes a booster fuel pump that can inject fuel immediately prior to the air intake on the burner assembly, and a post-compressor air throttle. An alternative fuel supply can use a premix of gas and air that goes through a larger hollow axle and fuel pipe. This allows more precise fuel control, and does not depend on the tangent speed of the fuel to create pressure to vaporize the fuel, thus allowing a slower idle speed of 10% or less like a normal gas piston engine, if using a piston air compressor.

Number 8 is the ceramic insulation around the burner to protect the fiberglass disc from being too hot. It has 16 mm (0.65 inch) thick walls of 1.5 grams per mL (93.6 lb/cf) density or less ceramic. It has to insulate the 1060 degree Kelvin (1450 F) temperature of the combustion from the fiberglass that cannot reach more than 420° K (300 degrees F.). It has holes drilled in the ceramic to allow the maximum compression strength while still having good insulation values of 1-3 Watts per M²/meter or less. Also the holes provide some air convection cooling. Number 12 is the convergent part of the throat for the nozzle that has a diameter of 3.6 mm (0.142 inches).

Number 18 is the divergent part of the nozzle that extends past the fiberglass exhaust outlet slightly outward to the side to prevent the 564° K (5550 F) exhaust gas from melting the epoxy. It has to be 1.96 times the throat area to get the maximum exhaust velocity of 1034 m/s (2274 mph). The upper part of the nozzle has to have a ceramic nozzle extension to extend the nozzle out and back to allow the angle of the exhaust to be about 25-30 degrees from the disc so at least 90% of the thrust produced is directed in the direction of rotation. From there the exhaust gas goes to the exhaust collection donut shaped collector #22 that directs it to the final exhaust which is Number 17. It directs the nozzle exhaust to get the maximum thrust leftover after the engine drive shaft power. It controls a maximum of 26 newtons (6 pounds) of leftover thrust for the whole engine.

There can be an ignition spark provided where the exhaust collector #22 meets the nozzle to ignite the air fuel mix that would be present at the end of the nozzle if the engine was being started for the first time. A priming pump can be utilized to push a small amount of liquid fuel onto the nozzle end so the trail of fuel that the igniter lights is as rich as possible to reduce the power of the explosion when the engine is first started. If the engine is traveling at 120 m/s (264 mph) forward speed, it can operate with the same fuel supply at an altitude up to 10 kilometers (33,000 feet). The air fuel ratio would be about 25:1.

Number 19 is the 24.5 mm (1 inch) final axle that spins at 3000 rpm. Number 20 is the oil pump in the oil sump. Number 21 is the non contact seal to prevent mixing of the exhaust and air even though #22 and #6 mostly do that task.

FIG. 2 is a front view of a high performance engine which is intended to have the most power per size possible with still the same or greater efficiency as a gasoline piston engine. It has 24% efficiency, which is 4% more than a common 250 kwt (330 horsepower) helicopter engine has.

The efficiency can be increased to 44% if the engine spins at 600 m/s instead of 500 m/s but this would require a 5 cm (2 inch) larger diameter engine. The efficiency could be increased to 38% as said previously by having a 10:1 compression ratio. The net power is 744 kwt (997 hp). Its rotor diameter is only about 31 cm (12.3 inches) diameter. It has 8 burners per rotor and 4 rotors, so its length of the 4 rotor assembly on the axle is 32 cm long (12.6 inches). The axial flow air compressor needs to have a pre pressure of 11.8 and the 300 m/s (660 MPH) speed change of the air creates the rest of the pressure up to 2 mpa (290 PSI). It needs to have a diameter of 19.5 cm (7.7 inches) and a 25 cm (10 inches) length. It uses 2.2 MW (2950 hp) (almost 75%) of the engines' gross power. The engine needs the same 12 cm (4.72 inch) thick impact guard or more if a burner breaks free, and 1 cm (⅜^{th} inch) clearance between the burner and impact shield. So the total outer dimensions of the engine are only about 57 on each side (22.4 inches).

The volume of said high performance engine is 185 liters (6.5 cubic feet). The power per cubic foot is 153 hp per cubic foot and 4 kwt/liter. This is about 3 times the power per size of a common 6.2 compression ratio 250 kwt (335 hp) helicopter turbine engine. The preferred version of this engine has an axial flow air compressor and the total engine has an estimated 6 kwt/kg (3.6 hp/lb) power density. If this alternative embodiment engine has a piston air compressor with a piston speed of 1 m/s (3.3 ft/second) instead of an axial flow air compressor, then it has estimated production cost of ¼^{th} the selling price of normal gasoline piston engines, and 1.8 kwt/kg (1.1 hp/lb) power to weight ratio. Even with the piston air compressor, its power per weight ratio is about 50% of the 3.9 kwt/kg 250 kwt (335 hp) engine and about 6 times the power weight ratio as a normal modern piston diesel engine, plenty of power per size and weight for motorcycles, snowmobiles, and propeller airplanes.

Number 1 is the 1 cm (⅜^{th} inch) thick S-glass composite that holds the burners in place. Even though carbon fiber epoxy composite has more strength compared to its density than S-glass, it would need to be 14 mm ( 9/16^{th}) thick instead of 10 mm (⅜^{th} inch) since its absolute leftover strength is less. There is stress from the centrifugal force of the burner (#9) weight and the force of the discs for the rotors spinning that have to be added to determine the safe thickness needed. The S-glass rotor would be less size, less total weight, and less cost. The burner unit (#9) is 42 mm (1.65 inch) across and has holes drilled to reduce the density from 3.1 g/cc (193 lb/ft³) to 1.5 g/cc (93.6 lb/ft³). This also allows air to be an insulator to bring the insulation value to about the same as normal porcelain (1-3 W/m²/m). It needs to be made out of one of the following kinds of silicon carbide: recrystallized, reaction sintered, nitride bonded, or the brand of silicon carbide being sold under the trademark Hexology. It can be made out of other materials with the same compression strength, maximum temperature, and insulation value, which excludes all or almost all modern metals and common ceramics as well. It needs about 128 mpa (18.6 kpsi) per specific gravity safe compression strength at the operating temperature to not crush under the centrifugal force.

Silicon nitride bonded is preferred for the outer layer because of its better insulation properties while the recrystallized or Hexology brand silicon carbide is preferred for the solid inside nozzle walls for its low porosity, high tensile strength to hold the gas pressure, and maximum temperature allowance. Number 8 is the 1 mm thick solid walls of the nozzle that have to hold to the gas pressure without leaking or breaking under pressure. The surrounding lighter density ceramic insulation holds the rest of the pressure. The gas temperature for the chemically correct ratio with 20:1 compression ratio is hotter than the maximum temperature of the silicon carbide (2000° k (3100° F.)) but a 30:1 or greater air fuel ratio brings the temperature low enough to avoid the need for cooling the nozzle walls.

The lower temperature ceramics that only allow 1600° K (2400° F.) are not allowed for the hottest gas temperature possible since the wall temperature is very close to the gas temperature because of the need for the insulation layer to protect the S-glass composite from the heat. If the engine has the 60:1 air fuel ratio, then the temperature is low enough to allow using all nitride bonded or reaction sintered, or a blend of alumina, quartz, and silicon carbide for greater insulation value to require less size and weight of the outer burner layer. A thin layer of tightly woven glass or quartz fabric can be placed in between the ceramic burner and the S-glass composite to reduce the total solid block ceramic thickness and operate as a shim to correct tolerances when assembling the components.

The need for nozzle insulation is more important for engines with small nozzle diameters to prevent the parasitic power loss from the heat escaping from the nozzle since the ratio of power to inside wall surface area is exponentially larger with an increase in engine size. With the small nozzle described for the FIG. 1 engine, the power needed to sustain a difference in temperature of 1060 degree Kelvin (1450 F) to 420° K (300 degrees F.) would be more than the engine produces if it had only 4 mm thick solid insulation. The throat needs to be about 1 cm (⅜^{th} inch) diameter. The proper are ratio of the end of the nozzle to the throat to get the maximum thrust is 3.1:1 and is shown at #5. The 184 Newtons (42 lbs) thrust from the 1207 m/s (2,660 mph) gas velocity from the nozzle is contained by the side bolts #2. They can be made out of alloy steel since the maximum total stress from centripetal and shear on them is only 272 mpa (39 kpsi) total if 8 g/cc (500 lb/ft³). The engine has left over thrust that cannot be more than 4.5 kilo Newtons (1000 lbs) and could be considerably less from the turns it has to make.

If the engine used a fuel supply of 11.9 grams (0.0262 lbs) per second, the fuel nozzle would need to be 0.252 mm diameter (0.005″). It is located on the end of the fuel pipe #6 coming from the 25 mm (1 inch) outer diameter hollow axle #7. The axle has a total of 820 N*M (607 ft*lbs) of torque applied to it. Since it has a hollow inside diameter of 1.41 cm ( 9/16 inch) and an outer diameter of 2.5 cm (1 inch), the total stress on the metal is 350 mpa (51 kpsi) so it needs to be made from a strong alloy such as the fuel line alloys needed for #3. The speed of the bearings is at their maximum of 50 m/s (164 feet/second) so the axle cannot be larger or else the outer tangent velocity would be too great for the bearings. Number 3 is the metal swirl burner and flame holder that allow the air from the 2 cm (¾^{th} inch) intake #4 to combine the 11.9 grams (0.0262 lbs) per second of alcohol fuel to mix with the 119 grams (0.262 lbs) per second of air, if using the 10:1 air fuel ratio. It would mix 89 grams (3 oz.) of fuel and 5.34 kgs (11.8 lbs) air if using a 60:1 air fuel ratio. The metal swirl burner, fuel nozzle and flame holder can be made from a material that has 100 mpa (14500 psi) safe yield strength per specific gravity (g/cc) such as Inconel 718, A286, Titanium, M252, Maraging 300, or Waspaloy.

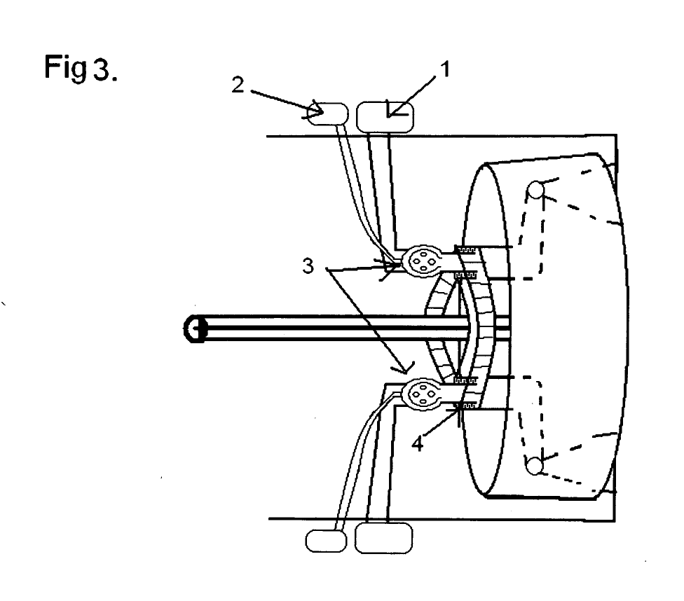

FIG. 3 shows an alternate fuel supply, which on its own, is similar to a normal turbine fuel supply. It has a stationary burner and fuel nozzle. This allows having a larger burner volume to try to get a higher air fuel ratio to reduce the tangent nozzle velocity needed to obtain 60% efficiency. It also allows a more precise controlled standard method of fuel and air delivery that has been proven successful in airplane turbines for many years. Number 1 is the air supply hose coming from the air tank that are both used to even out the uneven flow of a piston air compressor. It goes into the stationary burner assembly #3.

Number 2 is the fuel supply from the high pressure fuel pump that also goes into the stationary burner. Number 4 is where the air intake of the spinning nozzle assembly joins with the stationary burner. Instead of the burned air and fuel going through the axle, it goes in the side through a donut shaped air intake that has a non-contact labyrinth seal of the kind turbine engines have for its blade to inner wall seals. From there the exhaust gas get compressed by the velocity change of about 300 m/s (660 mph) from 11.8:1 to 20:1 and then escapes through the convergent divergent nozzle like all the other embodiments of this invention. Although normal turbines compress the air completely before the combustion, the engine works fine with compressing the exhaust so long as it is compressed prior to the convergent nozzle throat. A standard turbine ignition system can be utilized instead of the ignition system described for the moving burner.

The foregoing description is only illustrative of the invention. Various alternatives and modifications can be devised by those skilled in the art without departing from the claims of the invention. Thus, the present invention is intended to encompass all such alternatives, modifications and variances which fall within the scope of the appended claims.

What is claimed to be new:

1. A rotary power producing engine comprising:
A vibration free air compressor, a means of delivering said compressed oxidizer to intake of burner unit located between the axle and outer rotor rim, a burner unit to contain combustion products and allow ejection of gases therefrom whereby propulsive forces cause rotation of rotor assembly, a fuel pipe to deliver fuel to a swirl-inducing flame holder located centrally within burner unit to combust fuel and oxidizer, an axle to connect said rotor within the housing of engine producing mechanical rotation power, including means of separation of intake and exhaust constituents, including means of lubrication of friction regions, including outer shell to contain kinetic energy of ruptured burner unit, including exhaust collection annulus assembly thereby directing exhaust product from burner unit nozzle to expel gas through final exhaust nozzle.

2. A rotary assembly in claim 1 which said rotor assembly comprise twin parallel discs, which are perpendicular to axle and spinning parallel to plane of diameter, and said disc pair are located on opposite ends of said burner unit which discs connect at outer rim by curved ribbon matching the fillet radius of top of said burner unit to snugly contain burner unit in between said inner disc surfaces, also comprises multiple thrust producing burner units per rotor which are assembled and contained tightly in an radial array in between parallel discs of the rotor.

3. A rotor assembly in claim 2 whereas complete rotor assembly does not fail its purpose at tangential speeds of less than 800 m/s nor centripetal forces of less than 4 million newtons per kilogram (2 million pounds-force per pound weight) without utilizing a non-rotating outer wall of gas containment.

4. A burner unit from claim 1 whereas shape of said burner is a rectangular prism whereby outer edge is truncated by fillet method in the parallel direction of rotation with a radius of fillet equal to half the total side length of said rectangular prism, and also same end is truncated by fillet method in perpendicular to rotation direction of radius equal to the distance from the center of the drive axle in to the outermost edge of said burner unit to match curve of containment ribbon in claim 2.

5. A burner unit from claim 1 whereas combustion gas pipe located therein is surrounded by thermal insulation forming the structure of said unit's shape.

6. A burner unit from claim 1 which fully contains gas exhaust and does not collapse at a specific centrifugal force of less than 3 million newtons per kilogram (1.5 million pounds-force per pound weight).

7. A burner unit from claim 1 which contains a protuberance on the outer edge to house exit of divergent nozzle cross section, whereby combustion gas flow protrudes away to avoid contact of outer edge of aforementioned rotor disc in claim 3 in an angle not greater than 30 degrees parallel to rotation direction of rotor.

8. A burner unit from claim 1 whereby oxidizer intake section is located at the center of the square of the farthest quarter from the truncated side with respect to the rectangular prism and exhaust exit section is located at the center of the square in the quarter closest to the truncated side, and entrance and exits for oxidizer and combustion solution of burners are located on opposite sides.

9. A fuel air mixing component of claim 1 which said swirl burner and flame holder does not collapse under specific centrifugal stress of 1 million Newtons per kilogram (250 tons of force per pound of weight) while simultaneously performing the normal task of a fuel air mixing component which is centrally located in said burner unit of claim 5 containing a fuel nozzle, a flame holder therein to enable propagation of maximum initial combustion temperature of stiochiometric proportions, afterward gas subsequently encounters a gas swirl inducing cylinder with array of angled vanes to proliferate homogenization of additional air or oxidizer with combustion ingredients to enable equalization of said constituents to a temperature equilibrium prior to convergent nozzle cross section.

10. A vibration free air compressor which consists of an even number of matched by size and weight piston pairs and half the number of straight cylinder as pistons which said piston pair are located on same latitude plane which mirror each other by line at midpoint of each cylinder to parallel to piston drive axles, said piston pairs approach each other in a single cylinder until reaching near the midpoint of the single straight cylinder, then subsequently retreating each other, wherefore oscillation continues in each cylinder therefore producing compressed oxidizer. The other cylinder or cylinders have the piston pair approaching while the one other or even number of other piston pair in other cylinder is retreating while axle is spinning in a counter rotation direction at same speed.

11. An air compressor in claim 10, wherefore all formation and emanation of vibration is entirely eliminated therefrom.

12. A outer engine housing from claim 1 whereas housing consists of alternating layers of ceramic or glass insulation blanket with interposed thin layers of fabrics with high strength, ending at outermost layer with solid shell, so total thickness of housing enables sufficient strength to contain the kinetic energy of ruptured burner unit impacting said housing without causation of chasm creation on said outermost layer.

13. A rotary ramjet engine whereby total assemblage of apparatus is compact enough for both 4.6 kilowatt/liter (175 horsepower/cubic foot) at 1 MW 1350 hp size, burning 85% ethanol and 15% gasoline and a 20:1 compression ratio with 50% chemical efficiency exclusively from the combustion of air and fuel creating rotary driveshaft power in the invention with single direction of rotation, without stressing any part more than half the 0.2% yield stress, without requiring any additional consumables, without hot exhaust gas being utilized for steam production, nor nozzle exhaust causing rotation of second stage turbine or rotor, or any other technique other than above said process of creating engine rotary power.
